(19) United States
(12) Patent Application Publication
(10) Pub. No.: US 2010/0332326 A1
(43) Pub. Date: Dec. 30, 2010

(54) System And Methods For Positioning Information From A Plurality Of Users

(76) Inventor: Ron Ishai, Binyamina (IL)

Correspondence Address: The Law Office of Michael E. Kondoudis, 888 16th Street, N.W., Suite 800, Washington, DC, 20006, US

(21) Appl. No.: 12/867,365

(22) PCT Filed: Feb. 15, 2009
(86) PCT No.: PCT/IL09/00180

§ 371 Date: Aug. 12, 2010

(30) Foreign Application Priority Data
Feb. 13, 2008 (IL) 189505

(51) Int. Cl. H04W 4/02; G06Q 30/00; G08B 21/00; G06F 3/048

(52) U.S. Cl. 705/14.58; 455/456.3; 340/686.6; 715/780

(57) ABSTRACT

The present invention provides a system and methods for integrating position information from a plurality of users to inform users of other user's positions, events of interest, and locations of interest. Similarly, the invention relates to techniques for using real-time location information and information gathered from social networks and other internet-worked information sources to alert people of other individuals, places, and events of interest in the vicinity.

### FIELD OF THE INVENTION

The present invention pertains to a system (namely, a AYEKKA? system) and methods for positioning information from a plurality of users to inform e.g., users of other user's position, events of interest, and locations of interest. Similarly, the invention relates to techniques for using real-time location information and information gathered from social networks and other internet-worked information sources to alert people of other individuals, places, and events of interest in the vicinity.

### BACKGROUND OF THE INVENTION

Generally the information we have regarding our immediate surroundings is limited by what we gather from our biological senses of sight, sound etc. Due to the limited range and accuracy of these senses one might for example come within a few kilometers of a long-missed friend and never know it. The present invention relates to the use of real-time location information combined with information from the internet, to alert people of other individuals, places, and events of interest in the vicinity.

Several patents deal with interfaces between the internet and GPS systems. For example, U.S. Pat. No. 7,174,243 provides a wireless, internet-based system for monitoring and analyzing both GPS and diagnostic data collected from a vehicle. Specifically, the invention provides a system for collecting these types of data and analyzing them to provide improved determination and mapping of the vehicle's location. However this location information is not used to alert the driver to items of interest in his surroundings; rather his position information is transmitted to another party without further information being transmitted back to the driver.

Similarly Korean patent 20030066477 provides a taxi paging method using wireless Internet, a mobile phone and a global positioning system (GPS) to enhance convenience and stability of a call taxi. The system works by allowing a central GPS service provider to obtain positions of a taxi and a client and connect them. To use the service a client connects to a website on the Internet provided by a central service provider and inputs or clicks a destination. The central service provider tracks the position of the client and confirms a name and a phone number of the client through a connected number or an IP address. The central service provider searches taxis in a certain range by using GPS to check whether there is an empty taxi of whose desired destination is identical to the destination of the client. The central service provider transmits positions and information (e.g., car number or company) of searched taxis to the client. While informing users of an item of interest in the vicinity in real-time based on position information [a client is of interest to the driver, and a taxi is of interest to the client] it does not allow for a wealth of other types of interaction and information to be exchanged based on position, such as the vicinity of friends and acquaintances, events of interest in the vicinity, and places of interest in the vicinity.

French patent 2,826,489 provides a system of management in real time of the mobile machines of a company, intended to solve problems of precision in management of a distribution system. A great part of the realization of manufacturing costs depends on optimization of the movements and the control of the means of the company. By linking the position information of mobile units to a centralized data processing center such optimization can be effected. This system is intended to optimize distribution networks and does not speak to the problem of providing users with location-specific information correlated by a central information store.

In Korean patent 20020078952 a device and method for chasing a position on the Internet using a GPS terminal is provided to allow for a more stable living environment by providing an old person, dementia patient, or a preschool child with a GPS terminal for generating position data, thereby enabling a protector to sense the current position of the protection-objected person. However this invention does not allow for a wealth of other types of interaction and information to be exchanged based on position, such as the vicinity of friends and acquaintances, events of interest, and places of interest.

In German patent 10,029,105 a device is provided that contains a GPS receiver and mobile telephone, and uses GPS for position determination. It can call up special Internet pages in Wireless Markup Language format and enables the user to navigate with position and route data from an Internet-based database. But as in all of the aforementioned patents there is no allowance for the provision of a wealth of other types of interaction and information to be exchanged based on position, such as the vicinity of friends and acquaintances, events of interest, and user-specific places of interest.

Hence, a system for provision of real-time or near-real-time position-based information, such as the vicinity of friends and acquaintances, events of interest, and places of interest, by means of information transfer between a central server and a user providing real-time position information is still a long felt need.

### BRIEF DESCRIPTION OF THE DRAWINGS

In order to understand the invention and to see how it may be implemented in practice, a plurality of embodiments will now be described, by way of non-limiting example only, with reference to the accompanying drawings, in which

FIG. 1 schematically presents the flow of information in a basic embodiment of the AYEKKA? system, wherein the cellular company or companies 101 provide location information to the AYEKKA? server 105, which has gathered further information on relations between users using social websites 102, and advertising information from advertisers 103, performs coincidence detection upon this data, and accordingly sends GPA text messages to the customer phone 104, and furthermore updates Dynamic Geographic content such as a Google Earth layer 106;

FIG. 2 presents a simplified flowchart for coincidence detection 201 between users and other users, events, and places of interest;

FIG. 3 schematically presents the flow of information in a basic embodiment of the AYEKKA? system, wherein the AYEKKA? server 308 acts as an operator, connecting the roaming GPA users 310 with other roaming GPA users 310 by means of text messages or other communications routed through cellular provider 309, gathering information from online entities 301-305, while other AYEKKA? users 306 may be connected to the Google Earth server 305 which in turn receives dynamic data for the AYEKKA? layer from the AYEKKA? server 308, and still other users 307 may be directly connected to the AYEKKA? server; and,

FIG. 4 schematically depicts three of the databases used by the AYEKKA? server, these being a database linking cellular numbers, social web names, and locations 401, a database linking friends' numbers and criteria for GPA's 402, and a database containing local business names that want to send Location Selective Ads to AYEKKA? customers 403.

### SUMMARY OF THE INVENTION

The invention comprises a system and method for advising users of events, places, and people of interest in their surroundings by use of GPS position information, gathered through GPS, cellular radiolocation techniques, or otherwise; and information concerning the users' friends and interests, gathered through online social networks and questionnaires.

In broad terms, the apparatus is comprised of the following elements: a cellular phone or other wireless communication device; optionally a GPS receiver in communication with said cellular phone or wireless communication device; a cellular service provider or other provider of wireless communication; and a central server collecting user position information, user preferences, locations of interest, people of interest, events of interest, and similar information of potential interest to users of the system.

In broad terms, the method comprises steps as follows:

(i) User information is gathered by the central server from the user's social networks, including a list of friends and acquaintances, and possibly further profile information about the user such as interests and hobbies, etc;
(ii) A database of possibly interesting places and events is gathered and stored or otherwise made accessible to a central server, and periodically updated;
(iii) The user's current position is gathered from a user's GPS unit, or through cellular radiolocation, or through other means as will be obvious to those skilled in the art;
(iv) Said position information is transmitted to the central server by the cellular service provider;
(v) The central server checks continually if a given user is in the vicinity of a person, place, or event of interest, as judged by the user's position, the auxiliary user information, e.g., list of friends, interest, hobbies, etc., all other users' positions, and the database of possibly interesting places and events;
(vi) The central server sends a notification to the user, if the user is in fact in the vicinity of a person, place, or event of interest, by means of a cellular text message (e.g., SMS and the like), voice message, email, or other communications means as is obvious to those skilled in the art;
(vii) The central server relays messages between users, in the event that several users desire to be in communication by means of the central server, allowing for communication between these users without their revealing cellular numbers to one another.

It is within the core of the present invention that information of interest to a user, possibly including but not limited to the existence of people, places, and events that are within a designated distance, and/or time, of the user's present position, be transmitted to said user by a central server privy to one or more of the following, selected in a non-limiting manner from a group consisting of (i) the user's interests, friends, and other profile information; (ii) the position information of other users, and (iii) databases of the locations of possibly interesting places and events.

While the invention is susceptible to various modifications and alternative forms, specific embodiments thereof have been shown by way of example in the drawings and will herein be described in detail. It should be understood, however, that it is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide the AYEKKA? location-based information system.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment or invention. Furthermore, the particular features, structures, or characteristics may be combined in any suitable manner in one or more embodiments. Lastly, the terms “comprising”, “including”, “having”, and the like, as used in the present application, are intended to be synonymous.

The term ‘AYEKKA?’ refers to the system of the present invention for the use of position information from a plurality of users to inform users of other user's position, events of interest, and locations of interest.

The term ‘LOA’ refers to location oriented advertisements, these being advertisements directed to a particular person, based on that person's location.

The term ‘GPA’, is a conjunction of two terms: (i) GPS and (ii) AYEKKA?. The term refers to a message indicating proximity of one user of the AYEKKA? system to a friend or acquaintance who is also a user of the system.

The term ‘event GPA’ refers to a message indicating of an event interesting to the user that will occur in a short amount of time, near to the user.

The term ‘place GPA’ refers to a message indicating proximity of a place of interest to the user of the AYEKKA? system.

The term ‘STP GPA’ refers to a message indicating proximity that two users of the AYEKKA? system are traveling on the same platform.

The term ‘social network’ refers to a commercially available online networked community of friends and acquaintances such as Facebook™, Myspace™, online dating services, and others.

The term ‘coincidence detection’ refers to an algorithm that detects the condition that two entities are within a given spatial distance of one another, for example when two people are within 1 kilometer of each other, this may be detected by a coincidence detection algorithm.

The term ‘dynamic layer’ refers to a layer as used in commercially available modules, such as Google Earth™, which can display dynamically updated information, overlaid onto a map or other grid of information.

The term ‘plurality’ refers hereinafter to any integer number equal or higher 1, e.g., 2-10, especially 2-4.

### Basic Functions

Commercially available social networks such as FaceBook™, Friendster™, various dating services, ICQ™, MSN™, Skype™, Jajah™ and others provide users with various means to interact with friends and acquaintances known from offline encounters, and also to meet new friends online. An extended circle of friends is thus built online that it may interest a given user to meet in the real world and not only online. AYEKKA? provides a method allowing users to be notified when members taken from a specified set of other users are in the physical vicinity. For example, consider a trip to the banks of the Tigris river one might take for a vacation. By means of a web interface, one has previously indicated to the AYEKKA? system that one would be interested in meeting any of a certain set of online acquaintances who happen to be in one's vicinity. By means of the AYEKKA? system, one is informed that an online acquaintance is also vacationing on the banks of the Tigris, and thus the two can meet face-to-face. Without this system, the two might never know that they had been vacationing in the same vicinity, and would miss the chance to meet.

The indication that a contact is nearby can be done in several ways. The simplest is by the automated sending of a text message to the cellular phone of the user. For example the message ‘You have a GPA from Jeremy//FB’ would be sent from the AYEKKA? system to the cellphone of a user who has indicated that he/she wants to know when Jeremy, an acquaintance from FaceBook™ (abbreviated ‘FB’) is around. The user may then message the friend through the AYEKKA? system. The cellular numbers of the parties involved are in general not revealed for privacy.

The user's position information can be furthermore used by presenting this position information through online channels. Thus, for example it is within the core of the current invention that a Google Earth™ layer be provided showing users' position information. The Google Earth™ layer is a means whereby ‘layers’ of data can be overlaid upon the geographic substrate provided by the Google Earth™ map (a detailed satellite map of the world). Thus the position data of all of one's acquaintances who are using the AYEKKA? system can be presented as a set of moving flags on a map. Which users are privy to which other users' position information is controlled by privilege settings on the AYEKKA? system's servers that can be set by each user individually.

### Pinpointing Users' Location

Information concerning geographical location can today be gleaned from several sources, the most readily available being GPS receivers and cellular radiolocation. Cellular radiolocation capability is forced by law in the United States. Furthermore GPS receivers are now affordable and portable. With appropriate hardware and software these can be interfaced with cellular phones. According to a preferred embodiment of the present invention, either of those location information sources are used to send one's location to a central server. In the case of GPS the information is sent either from the cellphone or the cellular provider to the AYEKKA? server, while in the case of cellular radiolocation this information is sent either from the cellphone or from the cellular provider to the AYEKKA? server. The AYEKKA? server continuously compares position information to see if any two acquaintances who want to know of each others' vicinity are in fact physically close to one another. This operation might be called ‘coincidence detection’. It is worthwhile noting that the system of coincidence detection is not materially affected by the particular method of locating a user. Thus for the purpose of this patent proposal it is not important what technology is used to locate the user. The present technologies in place, GPS and cellular radiolocation, are sufficient and future technologies would be compatible as long as they provide location data in real-time or near-real-time.

### Further Applications, Examples

As an example of the utility of the system described above, consider two people who have learned together in university some 20 years ago. They have listed each other as friends on a social network and have indicated to the AYEKKA? server that they are interested in activating the GPA mechanism. They both happen to be in Rome, one on vacation and another at a conference. They both receive GPA's indicating their proximity, and they can thus have an impromptu reunion, when otherwise there is a good chance they would have missed each other.

It should be appreciated that the position-based information that can be provided extends beyond information concerning the vicinity of acquaintances. It is within the core of the present invention that the same system comprising a AYEKKA? server gathering realtime position information from a plurality of users be used in a number of other ways. Specifically, the user can be informed of places and events of interest by the AYEKKA? server, when said server is provided with databases of such places and events of interest.

As an example of these further capabilities of the system consider a fan of heavy metal music, who has moved to a new city. He has informed his social network of his musical taste in his online profile. The AYEKKA? server has been given access to this profile information, as well as information from other sources such as Google Earth™ layers. Through for instance a Google Earth layer or other source, the location of a heavy metal club in the user's vicinity is received by the AYEKKA? server, and furthermore the schedule of events of the club is downloaded by the AYEKKA? server. Let us imagine for the purposes of the example that a show by the user's favorite band will occur in a few hour's time. This information will be transmitted to the user by the AYEKKA? server in an ‘event GPA’. Furthermore when he goes to the show, he receives a series of 12 GPAs from online friends who happen to be attending the same show; he can meet them in person and so start his social life in the new city.

As an additional example consider a young person who returns to her hometown after the first years' study at an out-of-state university. On returning she receives GPA's from all of her hometown friends, and can accordingly plan to get together.

As an additional example consider a population struck by a military or natural disaster. The ensuing confusion and chaos could be ameliorated by the use of AYEKKA?. Concerned parties could check if any of their online acquaintances happen to be in the affected region, if they have managed to escape, are in the path of coming danger, and the like. Based on this information they might be able to help their acquaintance, by providing them with relevant information, e.g., where to find emergency medical attention, food, shelter, high ground, etc.

As an additional example consider two businessmen at a conference of medical equipment. One is a manufacturer of stent sterilization equipment and another is a developer of stent systems. Each having indicated on their profiles that they are interested in stent equipment, they both receive GPAs on arriving at the conference hall, and can meet to discuss possibilities of working together.

As an additional example consider unmarried individuals interested in finding a romantic partner. Such individuals can indicate on their AYEKKA? or dating site profile what sort of match they are looking for filtering possibilities for example by age, income, education, etc. When they are in the vicinity of a ‘match’ they receive a GPA informing them of such, and they can look around the room for the other person who also just received a GPA.

### Details of Operation

In a preferred embodiment of the invention, the user first registers a AYEKKA? account on the AYEKKA? site. This involves providing personal information including phone number and cellular phone coverage provider. Several automatic acts are then authorized:

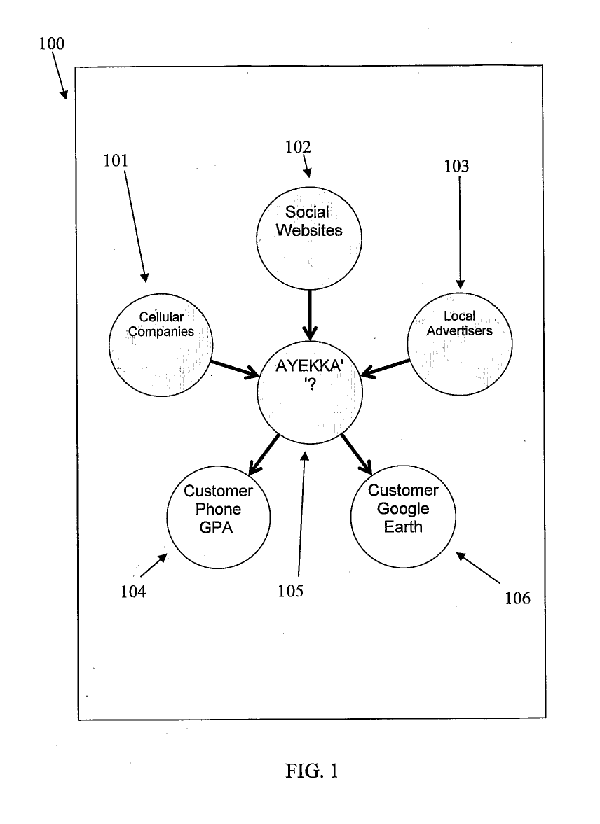

Extraction of the user's list of friends from any social network or website (102 in FIG. 1) the user indicates.

Extraction of further profile information from any social network or website (102 in FIG. 1) the user indicates.

Provision of position data to the AYEKKA? system (105 in FIG. 1), updated periodically, with a specified frequency such as once per quarter of an hour.

The transmission of GPA's cellular messages indicating vicinity from the AYEKKA? system to a subset of the user's social network acquaintances that have been indicated by said subset of acquaintances on the AYEKKA? system (104 in FIG. 1)

Integration of the position data with a Google Earth™ layer viewable by any of the user's social network acquaintances he/she chooses (106 in FIG. 1).

Once these steps have been authorized a discrete web page is generated allowing the user to control who is informed of the user's whereabouts, in what manner, and when this information is shared. This web page has a full list of the user's acquaintances from all his/her online social networks. All those acquaintances who have also signed up with the AYEKKA? system will be marked with an indication that they too are AYEKKA? users. Various variables can be controlled for each such user, these being divided into Time and Location variables. The time variables indicate when the given acquaintance will be informed of the user's whereabouts, e.g. ‘All day’, ‘Mornings Only’, ‘Weekdays only’, etc. The location variables will similarly filter the provision of location information, for example by ‘10 km’, a GPA is sent when the other user is within 10 km, ‘Same Town’, a GPA is sent when the other user is within the same city, ‘STP Only’, a GPA is sent when the other user is on the Same Traveling Platform, etc. Similarly, profile information is optionally collected for each user from their various social network accounts, and optionally furthermore from a AYEKKA?-specific profile page. On this page the user's characteristics may be indicated, including hobbies, favorite music, food, and the like as will be obvious to those skilled in the art.

In one embodiment of the invention provision is made for obtaining advertiser information from local advertisers (103 in FIG. 1). This information will consist of advertisers' locations, goods or services provided, and criteria concerning desired customer profiles. With this information the AYEKKA? server (105 in FIG. 1) may send targeted advertisements to appropriately selected customers within a given distance of a given advertiser. Customers will either agree to receive all ads sent by the AYEKKA? system or some subset of them, possibly also receiving no ads at all.

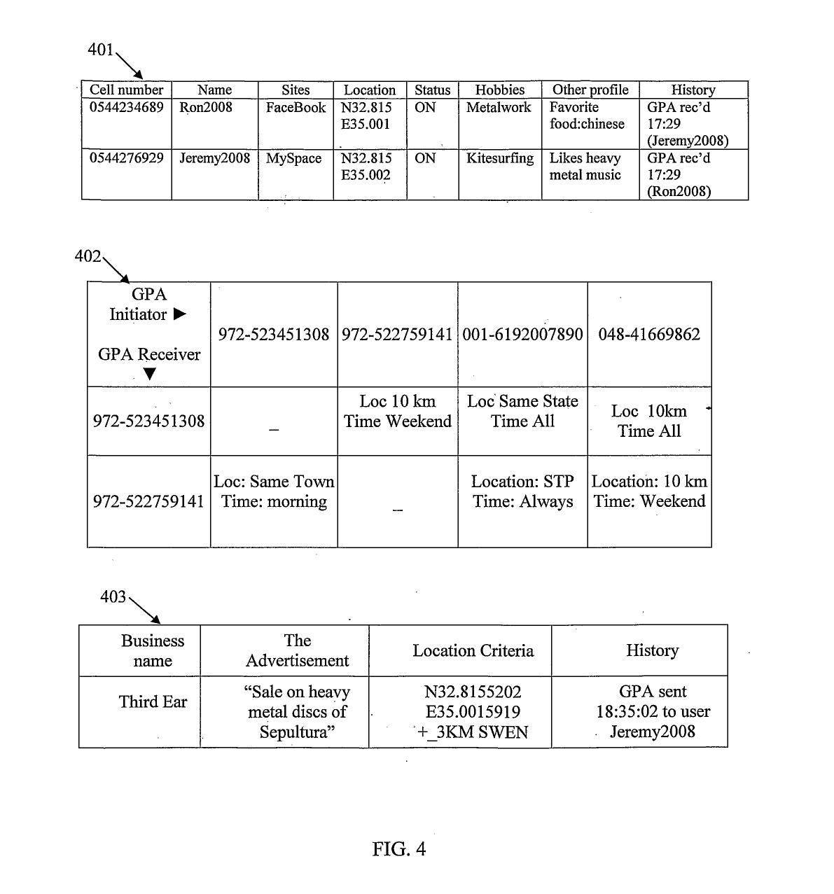

With reference to FIG. 4, a Database 401 is kept on the AYEKKA? server linking cellular numbers, social web names, present locations, and profile information. A second database 402 links users' friends numbers and criteria for GPA's. A third database 403 containing local business names that want to send Location Selective Adds to selected AYEKKA? customers and the businesses' sending criteria is also maintained on the main AYEKKA? server.

It is within the scope to the invention that the user's control over AYEKKA? be implemented not only through a web interface, but also through cellular phone. This can be done in several ways: by text messages, by proprietary software running on the cellphone, or by a web interface running on the phone.

Another element of the AYEKKA? user interface is a status control, whereby the user can determine whether acquaintances are privy to location information. In a preferred embodiment of the invention the status can be one of ‘On’, ‘Off’, ‘Help’, and ‘Ping’. These status states can be set either from the web page or from the cell phone of the user. The ‘On’ status allows acquaintances to be informed of a user's proximity through the sending of GPA text messages. ‘Off’ status prevents such position information from being sent. ‘Help’ status indicates that the user is in some state of distress and requires medical or law-enforcement assistance, and optionally sends GPAs to a previously chosen subset of the user's friends that he/she is in distress, as well as optionally sending the user himself GPA the location of the nearest friend. ‘Ping’ sends a GPA to all the user's friends who are in the vicinity.

It is within the parameters of the current invention that all AYEKKA? activity may be halted from the web interface, a useful feature in the case that the user's phone is stolen.

A further element on the user's AYEKKA? control page is a ‘Refresh Friends’ button, which re-checks the user's social network sites for friends and friends using AYEKKA?. This button or an associated one is provided for refreshing position data and sending it to the AYEKKA? server. This server in turn serves information to the Google Earth layer and thus this refresh will be reflected in an update of the Google Earth position information displayed.

Another element of the user's AYEKKA? control page is provision to accept/reject Location Oriented Advertisements (LOA's). These are advertisements sent to a user's cellphone based on his/her location and optionally furthermore based on his/her user profile(s) on the AYEKKA? system and/or on the various social networks to which he/she belongs. Thus advertisements for an orchid grower's outlet may be sent to a AYEKKA? user who is an orchid lover (as judged by his/her social-network profile or AYEKKA? profile) when that user passes near the orchid grower's outlet. As mentioned these advertisements may be allowed or blocked by means of a switch on the users AYEKKA? control page.

For the purposes of informing users of events or places of interest in the vicinity, further sources of information will be assimilated by the AYEKKA? server. For example, there exist Google layers with location based information concerning a multitude of businesses, restaurants, theatres, etc. Other such databases may be incorporated. Further sources of dynamic or continually updated information such as movie schedules, concert schedules, ship, plane, bus, and train arrivals and departures, and the like may also be accessed by the AYEKKA? server. In this way a user who indicates for instance that he is interested in finding transportation out of a given locale, can be provided with appropriate GPAs from the AYEKKA? server concerning the options available from near his current location.

It is within the scope of the present invention that a graphical user interface or GUI be provided for the purpose of user control over the AYEKKA? server. Options are provided on this GUI to control the friends/acquaintances; events, and sites of interest for which the AYEKKA? server should perform coincidence detection, when and under what circumstances coincidence detection should be performed, which other users and systems are privy to the position information of the individual user in question, and when and under what circumstances they are privy to said position information.

This GUI comprises a sign-in window with components which are selected from a group consisting in a non-limiting manner of

(i) text box for the user's name in a social internet site; (ii) A text box and/or menu for the name of the site; (iii) A text box for the user's cellular phone number (including international code); (iv) A child window of the main window with all the permissions the user gives the AYEKKA? System and an ‘Accept’ Check Box etc.

A second component of the GUI comprises a user control window with elements which are selected from a group consisting in a non-limiting manner (i) A set of ‘Radio Buttons’ concerning the users current mode (off, on, help, ping). Those buttons can be controlled by clicking them or by sending special numeric messages from the cellular phone; (ii) Refresh button for the friends “child window”, clicking it will do another check of friends from all social webs; (iii) “Import data to Google Earth” button; (iv) Check box for allowing advertisements; (v) Button for disconnecting from AYEKKA?; (vi) Child Window with a list of all of the user's friends from all social websites; (vii) The friend's name will be dark if the friend didn't sign into AYEKKA? yet; (viii) The friend's name will be red if the friend has signed into AYEKKA? but he is in the off mode; (ix) The friend's name will be green if the friend has signed in and currently is in one of the working modes; (x) Following the friend name will be two sets of “Radio Buttons”: one set concerning time criteria for sending GPA's (all day, weekends, afternoon only), and the other set concerning place criteria: (less than 10 km, Same town, Same state); etc.

Another component of the GUI allows the site administrator to make any search with any criteria he chooses in the data from the tables shown in the figures. The search will be made by choosing specific criteria or names from drop down lists and text boxes. The admin will have a continuous data flow concerning the statistics of the AYEKKA? usage—a log of GPAs sent, number of users, user locations, active external data connections, and the like as will be clear to those skilled in the art.

A further component of the GUI controls the format of the GPA message. The standard message “You have a GPA from User//Site” can be changed to contain text chosen by the user. In modern cellphones it is possible to add a photo or other media to a cellular message. It is thus within the provision of the invention that photos or other media chosen by the user be contained in the GPA message.

Another aspect of the GUI controls involves the cellphone. In one embodiment of the invention a button marked ‘AYEKKA?’ is made available on the numeric keypad or other hardware of the cellphone, which when pressed allows the user to be tracked by the AYEKKA? Server, directing the server to put the user in the ‘ON’ mode. This button has ‘toggle’ functionality; namely when pressed while in the ‘ON’ mode, this button changes the user's status to ‘OFF’ mode. Additionally an icon of a radar with moving beam may be displayed on the user's cellphone, indicating the user is in ‘ON’ mode. Additional icons may be envisioned for the other modes as will be obvious to those skilled in the art.

It is furthermore within the scope of the present invention a graphical presentation of user location data be provided, as a Dynamic Geographical Presentation Platform. It is also within the scope of the invention that this platform be presented as a layer in the Google Earth system.

The Dynamic Geographical Presentation Platform (DGPP) will comprise another GUI wherein

(i) By choosing the AYEKKA? layer in the DGPP the user will get ‘moving flags’ on a world, region, or local map. Each flag represents a friend's cell phone. The flag will contain this text: “Username/Site” where Username is the specific user's name and Site is the name of the user's main social network;
(ii) By pointing on the flag with the mouse a child window will be created containing the same data that appears in the users control window, concerning the specific friend; and
(iii) By clicking on the flag with the left mouse button a drop down list will be created asking the user to choose in what way he wants to contact the friend (Skype™, SMS by AYEKKA?, Message, etc. through the social web site).

It is within the preferred embodiment that the system allows the customer to invite his friends to use “AYEKKA?” even if “AYEKKA?” doesn't have an agreement with their connecting social web site. If for example the system cannot import the full list of a user's friends from a particular social networking site, the customer will be able to send his friends an invitation from his/her AYEKKA? account to use the system.

It is within the preferred embodiment that “AYEKKA?” is implemented as two different pieces of software. The first is for use on a central AYEKKA? server that integrates all needed information and produce GPA's. This information consists of user position information, user profile information, and additional information such as a database of locations and events of possible interest to various users. This software is called the ‘coincidence detection software’. The second software package is for implementation in cellular company's central computers. This software is called the ‘locating software’. The locating software interfaces with the coincidence detection software, which itself may be implemented on several different servers and is thus provided with the ability to interface with multiple instances of itself. By so constructing the algorithms, friends from distinct companies which implement AYEKKA? servers, or the case of a customer migration to another area, may all be seamlessly served by the AYEKKA? system.

It is within the provision of the invention that in phones with appropriate capabilities, the GPA message will enclose the friend's picture and/or other information such as voice messages, video clips, or other data as will be obvious to those skilled in the art, taken from the friend's Face Book site or chosen by him on his AYEKKA? control page.

It is within the provision of the invention that a “Mega GPA” be possible, this being a GPA that is sent to a group of friends that happen to be in the same place. The Mega GPA will have implications in the “Business-Customer” level—it would be possible to make an automatic auction between businesses for inviting the group.

Another provision of the invention is a GUI for a “AYEKKA?” generated map on mobile GPS+ Cellular systems: The customer will have the option to see his friends moving on his map and call them by indicating their representation on the screen, either by touching their icon on a touch-sensitive screen, entering an identification number, or by another method indicating which friend to communicate with as will be obvious to those skilled in the art.

In the preferred embodiment of the invention, the user's AYEKKA? control page may be controlled by cellphone. This may be accomplished in several ways. In its simplest guise, appropriate for 1^{st} generation cell phones and newer, this is accomplished by sending text messages to a AYEKKA? number provided for the service. For example by sending a text message with the number ‘1’ to the reserved AYEKKA? phone number *2222 a user can indicate to the AYEKKA? system that he/she wants to change status to ‘On’. Similarly by sending ‘2’ he chages status to ‘Off’, by sending ‘3’ he sends an SOS that changes status to Help, and by sending ‘4’ he sends a Ping.

A further refinement of the system of coincidence detection relates to detection of people traveling on the same platform. This is accomplished by the correlation of location and velocity information through time. If two users are located at approximately the same location, and are furthermore determined to be moving at the same velocity for at least some minimum amount of time, one may conclude that there is a high probability that they are traveling on the same transportation means, be it bus, train, plane, boat, or other. A GPA may then be sent to the parties involved informing them that a social-network acquaintance is traveling on the same platform. This type of GPA is called a ‘Same Traveling Platform’ or STP.

According to a preferred embodiment of the present invention, the GPA sent by the aforementioned process of GPS or radiolocation based coincidence detection does not contain the cellphone number of either party involved. Instead, the messages are routed through the AYEKKA? server, which acts as an intermediary between the two parties involved. In this way, each party's personal cell number remains private and unknown to the other party.

In the preferred embodiment of the present invention, the AYEKKA? server may be used to send messages directly to a social-network acquaintance through the Google Earth™ layer. This message might take one of several forms, such as a cellular phone text message sent to the other party's phone, a computer-based phone call through a VOIP network such as Skype™, or an online message sent to the other party's online account at his host social network(s). Further possibilities will be obvious to those skilled in the art. Thus a user, observing his acquaintances locations in the Google Earth™ layer, can call or send messages to them as he wishes, depending on their locations.

Large cellular companies might like to integrate “AYEKKA?” into their systems, running a AYEKKA? server internally, for their customers only.

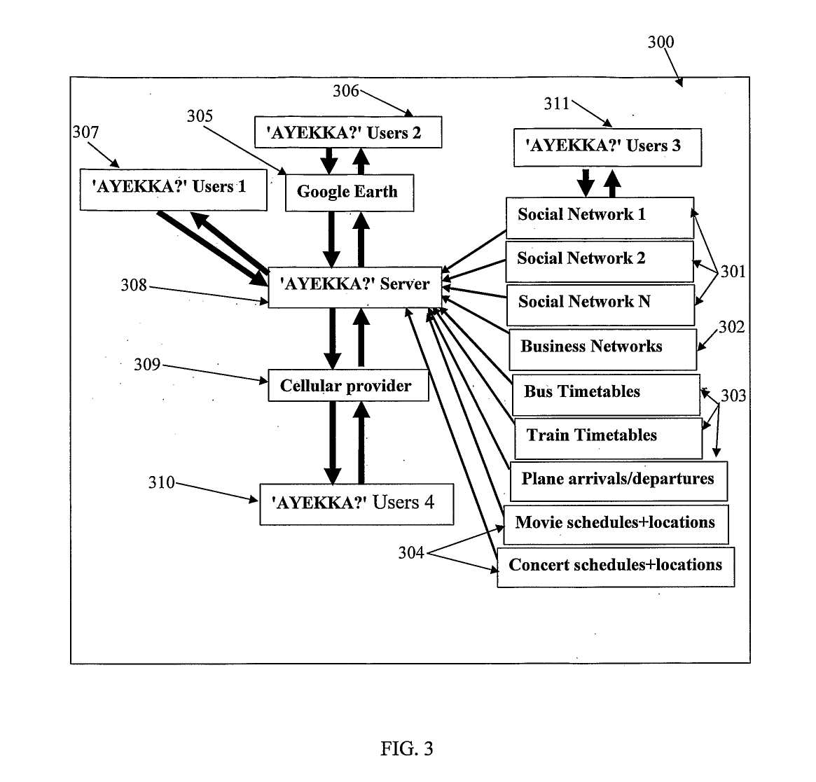

In FIG. 3 a more detailed diagram of routes of information flow in the AYEKKA? system is presented. Here the AYEKKA? server 308 acts as an operator, connecting the roaming AYEKKA? users 310 with other roaming AYEKKA? users 310 by means of text messages or other communications routed through cellular provider 309. In this way a user's cellular number is kept private from other users. Position data is also routed through the cellular provider. The server gathers information from online entities 301-305 these being social networks, business networks, and other sources of information of possible interest to the users. Other AYEKKA? users 306 may be connected to the Google Earth server 305 which in turn receives dynamic data for its AYEKKA? layer from the AYEKKA? server 308. Still other users 307 may be directly connected to the AYEKKA? server, for signing in, administering their accounts, adding friends, etc. AYEKKA? users 311 when connected to social networks may send their friends GPAs through applications on the social network sites 301 which route these messages to the AYEKKA? server 308.

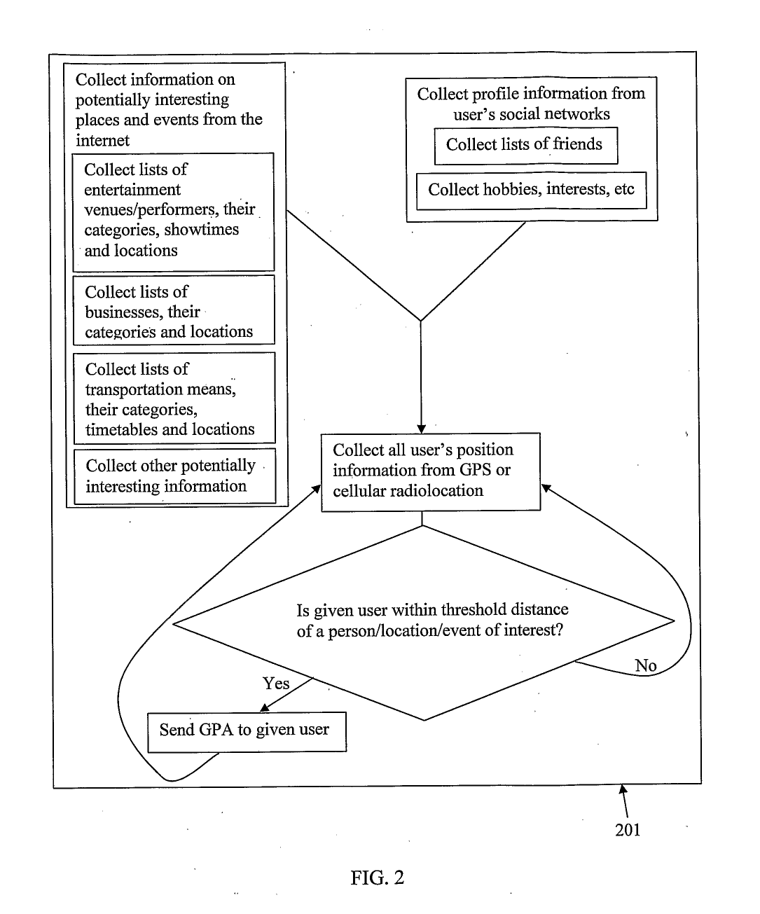

The crux of the AYEKKA? system is a set of methods implemented as computer algorithms running on the AYEKKA? server, users' cellphones, and the cellular-phone/wireless service providers' servers. These algorithms comprise:
a. Coincidence detection algorithms used for creating GPA's, which correlate position information of AYEKKA? users with position information of other users, events, locations, etc. that have been indicated as interesting by the user (either in particular or by class) to achieve detection of situations when users are within given distances of other users or events or locations of interest, and accordingly use the users' status to determine whether to send a GPA and to whom. This process is shown in flowchart form in FIG. 2.
b. Algorithms for the capture of user profile information, including importation of lists of friends from social network sites, importation of profile information from said sites including lists of hobbies, favorite music, food and the like as will be obvious to those skilled in the art, and profile pages to be completed by AYEKKA? users.
c. Algorithms for capturing position-based data and other information from services such as Google Earth and other internet databases for purposes of coincidence detection.
d. Algorithms used for performing location data transfer between “AYEKKA?” and the cellular companies. These may comprise (for example) the use of ‘deltas’ for minimizing the amount of data transferred, namely the sending of position information to the AYEKKA? server only when a user's position has changed by a given predetermined amount, and/or the sending of position information only at set intervals of time.
e. Algorithms for counting “AYEKKA?” initiated GPA's, Text-Messages and calls, for billing purposes as required by the cellular companies.
f. Special algorithms and sites for selling LSA's (Location Selective Advertisements).

It should be understood that the methods presented here are largely independent of the underlying technologies. Thus the method is general and will operate no matter what social networks are used, no matter what localization technique is used, i.e., not only GPS or GSM technology, no matter what wireless connectivity technique (i.e. not only GSM), no matter the capacity of the Cellular Phone, i.e., not only 2^{nd} generation, no matter the Dynamic Geographical Presentation Platform, i.e., not only Google Earth™, and no matter what the source or content of the auxiliary information of possible interest to users such as events of interest, locations of interest, and other as will be obvious to those skilled in the art.

It is within the scope of the invention that the methods presented above be carried out by means of devices other than that strictly known as a cellphone, such as personal digital assistants (PDAs), laptop computers with cellular or other wireless connectivity, or other devices as will be obvious to those skilled in the art.

User profile information will also be advantaeously gleaned from such sources as to-do lists, daily planners, and the like. This will find useful application especially insofar such tasklists are today more and more integrated into computerized organizing and planning systems such as the commercial system known as Microsoft Outlook. Such a tasklist, errand list, or to-do list will generally comprise a list of tasks, and the time frames in which they must be completed. Often the tasks will have some location based component, such as buying tickets at ticketmaster, buying stamps at a post office, and the like. For tasks that must be performed at a required location, the AYEKKA? system can simply alert the user when he or she is in proximity to the location required for the task. Then if one happens to be near e.g. a ticket outlet or grocery store, one will be reminded by the AYEKKA? system to buy tickets or groceries as needed. In cases where the location is not necessarily known, such as buying a particular stamp for one's stamp collection, further algorithms may be provided to (for instance) alert the user that he or she is in the vicinity of a seller of rare US stamps. This way, even if the task is not tied to a particular time or a known location, the user of the AYEKKA? system can be alerted to a potentially interesting location that he or she is passing. Thus the system provides for capturing information from online sources such as: planners, to-do lists, tasklists, interests, hobbies, collections, favorite fashion labels, favorite artists, foods, music, and the like, as will be obvious to one skilled in the art. When the user is in the vicinity of any of these potentially interesting locations as gleaned from any of the aforementioned sources, the user may be alerted (depending upon the user's preferences as set in the system) by (for instance) a cellular text message such as “You are near a supermarket, and you need to buy 3 kg sugar”.

1-3. (canceled)

4. A method for integrating location data with social network data, said method comprising steps of:
a. providing users' social network data to a networked server;
b. periodically providing users' current physical location data to said networked server;
c. informing users by cellular text message when other selected users are in the vicinity;
whereby users are put into contact with members of their social networks when in the physical vicinity.

5. A method for detecting coincidence between users, places of interest to said users, and events of interest to said users, comprising steps of:
a. obtaining profile information concerning the users' characteristics, said characteristics being selected from the group consisting of: places of interest; events of interest; tasks to be done; friends and acquaintances of interest from online social network sites; and direct input from said users;
b. storing and periodically updating said profile information on a central server;
c. periodically obtaining and uploading to said central server the locations of said users, said locations being determined by a method selected from a group consisting of: GPS receiver carried by the user; cellular radiolocation techniques on the part of the user's cellular provider; Wi-Fi locating techniques; BlueTooth locating techniques; and satellite telephone locating techniques;
d. calculating the matrix of distances between each user and all other users of interest, places of interest, and events of interest;
e. alerting users when they are within less than a predetermined threshold distance of other users of interest, places of interest, and events of interest by means selected from a group consisting of: cellular messaging, automated voice messaging, and emailing the users;
thereby implementing a real-time coincidence detection system making use of online social network data.

6. The method of claim 5 wherein location data transfer between said server and cellular phone service companies is minimized by means selected from a group consisting of: sending differences between current and previous positions instead of absolute positions, sending of said differences only when they exceed a certain threshold, and sending of position information only at set intervals of time.

7. A method for targeting advertising of potential customers who are within a certain threshold distance of a given business comprising steps of:
a. obtaining position and profile information from advertisers, said information comprising characteristics selected from the group consisting of: said advertisers' physical location; information relating to the goods or services provided by said advertisers, and technical and commercial characteristics of said goods or services;
b. obtaining profile information concerning said potential customers comprising characteristics selected from a group consisting of said potential customers' social networks; online questionnaires; credit histories; and purchase histories;
c. periodically obtaining and uploading to a central server the locations of said potential customers;
d. calculating the matrix of distances between a given user and all advertisers' locations;
e. alerting users when they are within less than a threshold distance of an advertiser's location by means selected from the group consisting of: cellular messaging; automated voice messaging; and email;
thereby implementing a position-based targeted advertising system making use of social network data.

8. A system for the integration of users' physical location data with network data comprising:
a. a networked server connected to the internet, provided with profile information concerning said users comprising characteristics selected from a group consisting of: the user's friends; the user's interests; the user's hobbies; the user's errands; and the user's task lists; said networked server adapted to glean said profile information from social websites;
b. locating means adapted to provide users' physical location periodically to said networked server;
c. a database comprising points of interest selected from the group consisting of: locations; classifications; timetables; schedules of events; business locations; venues; locations of interest; and events of interest; said database being stored on or accessible to said networked server;
d. informing means, said informing means selected from the group consisting of: cellular text messages; voice messages; emails; and wireless communications;
e. a coincidence detector adapted to determine when users are within predetermined distances of points of interest, and further adapted to inform users of said coincidence by means of said informing means, said coincidence detector comprising an algorithm running on said networked server;
wherein said system is adapted to implement a real-time information source of location-relevant data that is of interest to the user that gleans information from social websites.

9. The system of claim 8 wherein said locating means is selected from a group consisting of: GPS receiver carried by the user; cellular radiolocation; Wi-Fi locating techniques; BlueTooth locating techniques; and satellite telephone locating techniques.

10. A system for the integration of users' location data with social network data, said system comprising:
a. a networked server continuously updated with said users' social network data and said users' physical location data;
b. informing means adapted to send text messages to said users, when other selected users are in their physical vicinity;
wherein users are informed of the presence of members of their social network in their physical vicinity.

11. A system for the detection of coincidence between users of the method, places of interest to said users, and events of interest to said users, comprising:
a. a contact database containing profile information selected from the group consisting of: users' places of interest; events of interest; task lists; errand lists; and friends and acquaintances of interest; said profile information taken from online social network sites;
b. a central server in communication with said contact database;
c. a location database containing continually updated user locations derived using locating means selected from a group consisting of: GPS receiver carried by the user; cellular radiolocation; Wi-Fi locating techniques; BlueTooth locating techniques; and satellite telephone locating techniques;
d. algorithmic means to calculate a matrix of distances between each element in said location database and all entities in said contact database;
e. informing means adapted to send alerts to users when they are within less than a threshold distance of another user of interest, place of interest, or event of interest, said alterts bing selected from the group consisting of: cellular text messages; automated voice messages; and emails;
wherein said system is adapted to implement a position-based real-time coincidence detection system.

12. The system of claim 11 wherein location data transfer between said server and said users is minimized by means selected from the group consisting of: sending of differences between current and previous positions instead of absolute positions; sending of said differences only when they exceed a preselected threshold; and sending of position information only at set intervals of time.

13. A system for targeted advertising of potential customers who are within a certain threshold distance of a given business; said system comprising:
a. a position database of position and profile information of advertisers including their physical locations, and information relating to the goods and/or services provided by said advertisers;
b. a profile database of profile information of said potential customers gleaned from a set of information sources comprising said potential customers' social networks, online questionnaires, and credit histories;
c. a central server to which locations of said potential customers are uploaded periodically, said locations being gleaned by means selected from the group consisting of: GPS receiver carried by the potential customer; cellular radiolocation; Wi-Fi locating techniques; BlueTooth locating techniques; and satellite telephone locating techniques;
d. a matrix of distances between a given potential customer and all advertisers' locations, said matrix being compiled on said central server;
e. informing means adapted to inform said potential customers when they are within a predetermined threshold distance of an advertiser's location, said informing means selected from the group consisting of: cellular text messages; automated voice messages; and emails;
wherein said system is adapted to implement a position-based targeted advertising system using information obtained from social networks.

14. A GUI comprising modules which are selected from a group consisting of
a. a sign-in window with components selected from
i. a text box for the user's name in a social network site
ii. a text box and/or menu for the name of said social network site
iii. a text box for the user's cellular phone number
iv. a child window of the main window providing a set of radio buttons controlling user permissions for the AYEKKA? System
b. a user control window with elements selected from
i. a set of ‘radio buttons’ concerning the users current mode comprising ‘off’, ‘on’, ‘help’, and ‘ping’ buttons, said buttons being controlled by clicking them or by sending special numeric messages from a cellular phone
ii. a refresh button which will re-check and if necessary re-import data concerning the user's list of friends on said social networks,
iii. a button which imports data to a selected
iv. a check box for allowing advertisements,
v. a button for disconnecting from AYEKKA?,
vi. a child window with a list of all of the user's friends from all social websites, wherein
1. The friend's name will be dark if the friend didn't sign into AYEKKA? yet.
2. The friend's name will be red if the friend has signed into AYEKKA? but he is in the off mode.
3. The friend's name will be green if the friend has signed in and currently is in one of the working modes.
c. two sets of radio buttons, comprising a first set of radio buttons controlling time criteria for sending GPA's, and a second set of radio buttons controlling place criteria for sending GPA's user GUI control window for control over the format of the GPA message, allowing for editing of the GPA message text as well as addition of other media to the message taken from a group comprising pictures, sound clips, video clips, and links,
d. a site administration search window comprising a set of drop down lists, text boxes, text fields, and buttons providing search capabilities on a set of databases according to criteria chosen from a group including
a. telephone number
b. actual name
c. username
d. location
e. profile
f. history
g. status
h. social network site
e. a site administration overview window displaying the statistics of AYEKKA? usage, comprising a log of GPAs sent, number of users, user locations, and active external data connections;
f. a button marked ‘AYEKKA?’ on the user's cellphone which when pressed allows the user to be tracked by the AYEKKA? server in the ‘ON’ mode, and when pressed while in the ‘ON’ mode changes the user's status to ‘OFF’ mode
g. an icon of a radar with moving beam displayed on the user's cellphone indicating the user is in ‘ON’ mode;
wherein all of the above controls may be implemented on a AYEKKA? server, cellular phone, or other digital device, and wherein the above controls together provide a comprehensive means of control over a AYEKKA? server on the part of both users and administrators.
